(19) United States
(12) Patent Application Publication
(10) Pub. No.: US 2024/0361207 A1
(43) Pub. Date: Oct. 31, 2024

(54) WEAR DIAGNOSIS SYSTEM AND METHOD FOR FLOATING TILE OF OIL RECEIVER BASED ON INDUSTRIAL INTERNET

(71) Applicants: HUANENG LANCANG RIVER HYDROPOWER INC., Kunming City (CN); HYDRO POWER LOWER SESAN 2 CO., LTD, Phnom Penh (KH)

(72) Inventors: Songlin YANG, Kunming City (CN); Yafeng ZAN, Kunming City (CN); Zhaochun WANG, Kunming City (CN); Jin LI, Kunming City (CN); Zhifeng YIN, Kunming City (CN); Peng GUAN, Kunming City (CN); Zicheng GONG, Kunming City (CN); Zhongjun XU, Kunming City (CN); Bo XIE, Kunming City (CN); Jianshe YANG, Kunming City (CN)

(21) Appl. No.: 18/430,530

(22) Filed: Feb. 1, 2024

Related U.S. Application Data
(63) Continuation of application No. PCT/CN2024/071490, filed on Jan. 10, 2024.

(30) Foreign Application Priority Data
Apr. 28, 2023 (CN) 202310483529.2

(51) Int. Cl. G01M 99/00; F03B 11/00

(52) U.S. Cl. CPC G01M 99/005; F03B 11/008; F05B 2260/80

(57) ABSTRACT

A wear diagnosis system and method for a floating tile of an oil receiver based on industrial Internet are provided and includes the following. The plurality of vibration sensors are installed on the oil receiver of a hydroturbine, the vibration sensors are configured for collecting vibration data of the oil receiver. The plurality of swing sensors are installed on the oil receiver of the hydroturbine, and the swing sensors are configured for collecting swing data of the oil receiver. The monitoring subsystem is configured for collecting start-stop information of an oil pump of an oil collecting device of the hydroturbine, an oil level of a hub high-level oil tank and unit load information. The test result collection subsystem is configured for collecting oiling test results of each oil tank of the hydroturbine. The diagnosis subsystem is configured to diagnose whether the floating tile of the oil receiver is worn.

### CROSS REFERENCE TO RELATED APPLICATION

This patent application claims the benefit and priority of Chinese Patent Application No. 202310483529.2, filed on Apr. 28, 2023, the disclosure of which is incorporated by reference herein in its entirety as part of the present application.

### TECHNICAL FIELD

The disclosure relates to the field of wear diagnosis, in particular to a wear diagnosis system and method for a floating tile of an oil receiver based on industrial Internet.

### BACKGROUND ART

The oil receiver is an important part of bulb tubular hydroturbine. The main function of the oil receiver is to introduce the pressure oil of the speed regulation system from the fixed oil pipe into the rotating operating oil pipe and transfer it to the blade relay, so as to adjust opening degree of the blade in time and effectively, so that the unit can always run in the combined working condition. At the same time, the oil receiver can also introduce the gravity oil of a hub high-level oil tank from the fixed oil pipe to the rotating operating oil pipe and transport it into hub body of the wheel, so that the oil pressure inside the hub body is greater than the external water pressure, and prevent the river water from entering inside of the hub body to cause damage to all components when the seal of the blade is damaged. As the core component of the oil receiver, the floating tile is mainly used to guide and stabilize the running operating oil pipe, and used to isolate and seal the pressure oil in the opening and closing chambers of the blade to prevent the high-pressure oil in the two chambers from channeling each other. When the floating tile is seriously worn, the oil leakage amount of the oil receiver will increase, the oil pump of the oil collecting device will start frequently, and the oil level of the hub high-level oil tank will continue to drop; the turbine oil is polluted, the granularity exceeds the standard, the guide blade on the governor and the blade side filter screen are seriously blocked, and the solenoid valve is stuck; the internal seals of the main matching of the guide blade and blade are damaged, and the opening and closing chambers of the blade and guide blade relay are showed channeling oil, and the blade moves slowly and twitches frequently. When a large amount of channeling oil, there will be problems such as difficult or even impossible operation of the blades, which will lead to the inability to adjust the load of the unit. Therefore, whether the floating tile works normally will directly affect the stability of the governor system and the safety of the unit operation.

However, because the floating tile of the oil receiver is installed in the oil receiver body, it can not be visually inspected when the unit is in normal operation, and it must be disassembled after the unit is shut down to find out whether there is a problem, which greatly consumes manpower and material resources, reduces the equivalent availability coefficient of the unit and reduces the power generation benefit. Therefore, it is urgent to provide a technical scheme that can diagnose the wear of floating tile of oil receiver in time and accurately.

### SUMMARY

The disclosure provides a wear diagnosis system and method for a floating tile of an oil receiver based on industrial Internet, in order to at least solve the technical problem that the wear of floating tile of the oil receiver can not be diagnosed timely, accurately and in real time because floating tile of the oil receiver is installed in the oil receiver body.

A first aspect embodiment of the disclosure provides the wear diagnosis system for a floating tile of an oil receiver based on industrial Internet. The wear diagnosis system includes multiple vibration sensors, multiple swing sensors, a monitoring subsystem, a test result collection subsystem and a diagnosis subsystem;
the plurality of vibration sensors are installed on the oil receiver of a hydroturbine, and the plurality of vibration sensors are configured for collecting vibration data of the oil receiver and sending the vibration data to the diagnosis subsystem;
the plurality of swing sensors are installed on the oil receiver of the hydroturbine, and the plurality of swing sensors are configured for collecting swing data of the oil receiver and sending the swing data to the diagnosis subsystem;
the monitoring subsystem is configured for collecting start-stop information of an oil pump of an oil collecting device of the hydroturbine, an oil level of a hub high-level oil tank and unit load information, and sending the start-stop information of the oil pump of the oil collecting device, the oil level of the hub high-level oil tank and the unit load information to the diagnosis subsystem;
the test result collection subsystem is configured for collecting oiling test results of each oil tank of the hydroturbine and sending the oiling test results of each oil tank to the diagnosis subsystem;
the diagnosis subsystem is configured to diagnose whether the floating tile of the oil receiver is worn based on the vibration data and the swing data of the oil receiver, the start-stop information of the oil pump, the oil level of the hub high-level oil tank, the unit load information and the oiling test results of each oil tank.

In some embodiments, the plurality of vibration sensors are respectively installed in an X direction and a Y direction of an upstream of the oil receiver of the hydroturbine, and in an X direction and a Y direction of a downstream of the oil receiver;
the plurality of swing sensors are respectively installed in an X direction and a Y direction of an end cover on the downstream of the oil receiver of the hydroturbine.

In some embodiments, the wear diagnosis system for the floating tile of the oil receiver further includes an encoding module;
the encoding module is configured for KKS coding on the vibration data and the swing data of the oil receiver, the start-stop information of the oil pump, the oil level of the hub high-level oil tank, the unit load information and the oiling test results of each fuel tank, before sending the vibration data and the swing data of the oil receiver, the start-stop information of the oil pump, the oil level of the hub high-level oil tank, the unit load information and the oiling test results of each fuel tank to the diagnosis subsystem.

In some embodiments, the oiling test results of each fuel tank include:
an oiling test result of a governor oil-return tank, an oiling test result of the hub high-level oil tank, and an oiling test result of an oil collecting device oil tank;
where the oiling test results include granularity and oil color.

In some embodiments, the diagnosis subsystem is provided with a vibration data alarm threshold, a swing data alarm threshold, an oil pump start interval threshold, an oil level decline rate threshold, a granularity threshold and a fault oil color.

In some embodiments, a calculation formula of the oil pump start interval threshold is as follows:

g=j−j×20%
where g is the oil pump start interval threshold and j is an oil pump start interval average value;
a calculation formula of the oil level decline rate threshold is as follows:

s=x+x×20%
where s is the oil level decline rate threshold, and x is an oil level normal decline rate of the hub high-level oil tank.

In some embodiments, the diagnosis subsystem includes a judging subunit and a diagnosis result determining subunit;
the judging subunit is configured to judge whether a first fault occurs based on the unit load information and the vibration data in a preset time period;
the judging subunit is further configured to judge whether a second fault occurs based on the unit load information and the swing data in the preset time period;
the judging subunit is further configured to judge whether a third fault occurs based on the start-stop information of the oil pump of the oil collecting device in the preset time period;
the judging subunit is further configured to judge whether a fourth fault occurs based on the oil level of the hub high-level oil tank in the preset time period;
the judging subunit is further configured to judge whether a fifth fault occurs based on the oiling test results, the granularity threshold, and the fault oil color of each oil tank in the preset time period;
the diagnosis result determining subunit is configured for diagnosing a wear of the floating tile of the oil receiver when the first fault, the second fault, the third fault, the fourth fault and the fifth fault occur simultaneously.

In some embodiments, in a case of the first fault, the vibration data of the oil receiver continuously increases under a same working condition, and the vibration data is greater than or equal to the vibration data alarm threshold;
in a case of the second fault, the swing data of the oil receiver continuously increases under the same working condition under the preset time period, and the swing data is greater than or equal to the swing data alarm threshold;
in a case of the third fault, a start-stop interval time of the oil pump is less than or equal to the oil pump start interval threshold;
in a case of the fourth fault, a drop speed of the oil level of the hub high-level oil tank is greater than or equal to the oil level decline rate threshold;
in a case of the fifth fault, the oiling test results of each fuel tank are unqualified.

In some embodiments, the wear diagnosis system for the floating tile of the oil receiver includes a display module;
the display module is respectively connected with the vibration sensors, the swing sensors, the monitoring subsystem, the test result collection subsystem and the diagnosis subsystem;
the display module is configured for displaying the vibration data and the swing data of the oil receiver, the start-stop information of the oil pump, the oil level of the hub high-level oil tank, the unit load information, the oiling test results and diagnosis results of each oil tank;
the display module is further configured to display a vibration trend and a swing trend of the oil receiver, a start-stop interval trend of the oil pump of the oil collecting device under a same load and a oil level change trend of the hub high-level oil tank.

The second aspect embodiment of the disclosure provides a wear diagnosis method for a floating tile of an oil receiver based on industrial Internet. The wear diagnosis method includes:
collecting vibration data and swing data of the oil receiver of a hydroturbine, start-stop information of an oil pump of an oil collecting device, an oil level of a hub high-level oil tank and unit load information;
obtaining oiling test results of each oil tank of the hydroturbine;
diagnosing whether the floating tile of the oil receiver is worn based on the vibration data and the swing data of the oil receiver, the start-stop information of the oil pump, the oil level of the hub high-level oil tank, the unit load information and the oiling test results of each oil tank;
where, the vibration data of the oil receiver of the hydroturbine is collected based on multiple vibration sensors respectively installed in an X direction, a Y direction of an upstream of the oil receiver of the hydroturbine, and in an X direction, a Y direction of a downstream of the oil receiver;
the swing data of the oil receiver of the hydroturbine is collected based on multiple swing sensors respectively installed in an X direction and a Y direction of an end cover of the downstream of the oil receiver of the hydroturbine.

The technical scheme provided by the embodiment of the disclosure has at least the following beneficial effects.

A wear diagnosis system and method for a floating tile of an oil receiver based on industrial Internet are provided. The system includes multiple vibration sensors, multiple swing sensors, a monitoring subsystem, a test result collection subsystem and a diagnosis subsystem; the plurality of vibration sensors are installed on the oil receiver of a hydroturbine, and the plurality of vibration sensors are configured for collecting vibration data of the oil receiver and sending the vibration data to the diagnosis subsystem; the plurality of swing sensors are installed on the oil receiver of the hydroturbine, and the plurality of swing sensors are configured for collecting swing data of the oil receiver and sending the swing data to the diagnosis subsystem; the monitoring subsystem is configured for collecting start-stop information of an oil pump of an oil collecting device of the hydroturbine, an oil level of a hub high-level oil tank and unit load information, and sending the start-stop information of the oil pump of the oil collecting device, the oil level of the hub high-level oil tank and the unit load information to the diagnosis subsystem; the test result collection subsystem is configured for collecting oiling test results of each oil tank of the hydroturbine and sending the oiling test results of each oil tank to the diagnosis subsystem; the diagnosis subsystem is configured to diagnose whether the floating tile of the oil receiver is worn based on the vibration data and the swing data of the oil receiver, the start-stop information of the oil pump, the oil level of the hub high-level oil tank, the unit load information and the oiling test results of each oil tank. According to the technical scheme provided by the disclosure, the wear condition of the floating tile of the oil receiver can be monitored in real time, and the accuracy and timeliness of the wear discovery of the floating tile of the oil receiver are improved.

Additional aspect and advantages of the disclosure will be set forth in part in the following description, and in part will be apparent from the following description, or may be learned by practice of the disclosure.

### BRIEF DESCRIPTION OF THE DRAWINGS

The above-mentioned and/or additional aspects and advantages of the disclosure will become apparent and easy to understand from the following description of embodiments taken in combination with the attached drawings, in which:

FIG. 1 is a first structural diagram of a wear diagnosis system for a floating tile of an oil receiver based on industrial Internet according to an embodiment of the disclosure;

FIG. 2 is a second structural diagram of the wear diagnosis system for a floating tile of an oil receiver based on industrial Internet according to an embodiment of the disclosure;

FIG. 3 is a structural diagram of a diagnosis subsystem according to an embodiment of the disclosure;

FIG. 4 is a third structural diagram of the wear diagnosis system for a floating tile of an oil receiver based on industrial Internet according to an embodiment of the disclosure; and

FIG. 5 is a flowchart of a wear diagnosis method for a floating tile of an oil receiver based on industrial Internet according to an embodiment of the disclosure.

List of reference characters: 1 vibration sensor; 2 swing sensor; 3 monitoring subsystem; 4 test result collection subsystem; 5 diagnosis subsystem; 6 encoding module; and 7 display module.

### DETAILED DESCRIPTION OF THE EMBODIMENTS

Hereinafter, embodiments of the disclosure will be described in detail, examples of which are illustrated in the attached drawings, where the same or similar reference numerals throughout indicate the same or similar elements or elements having the same or similar functions. The embodiments described below by referring to the attached drawings are exemplary and are intended to explain the disclosure, and should not be construed as limiting the disclosure.

A wear diagnosis system and method for a floating tile of an oil receiver based on industrial Internet are provided. The system includes multiple vibration sensors, multiple swing sensors, a monitoring subsystem, a test result collection subsystem and a diagnosis subsystem; the plurality of vibration sensors are installed on the oil receiver of a hydroturbine, and the plurality of vibration sensors are configured for collecting vibration data of the oil receiver and sending the vibration data to the diagnosis subsystem; the plurality of swing sensors are installed on the oil receiver of the hydroturbine, and the plurality of swing sensors are configured for collecting swing data of the oil receiver and sending the swing data to the diagnosis subsystem; the monitoring subsystem is configured for collecting start-stop information of an oil pump of an oil collecting device of the hydroturbine, an oil level of a hub high-level oil tank and unit load information, and sending the start-stop information of the oil pump of the oil collecting device, the oil level of the hub high-level oil tank and the unit load information to the diagnosis subsystem; the test result collection subsystem is configured for collecting oiling test results of each oil tank of the hydroturbine and sending the oiling test results of each oil tank to the diagnosis subsystem; the diagnosis subsystem is configured to diagnose whether the floating tile of the oil receiver is worn based on the vibration data and the swing data of the oil receiver, the start-stop information of the oil pump, the oil level of the hub high-level oil tank, the unit load information and the oiling test results of each oil tank. According to the technical scheme provided by the disclosure, the wear condition of the floating tile of the oil receiver can be monitored in real time, and the accuracy and timeliness of the wear discovery of the floating tile of the oil receiver are improved.

Hereinafter, a wear diagnosis system and method for a floating tile of an oil receiver based on industrial Internet according to the embodiment of the disclosure will be described with reference to the attached drawings.

### Embodiment 1

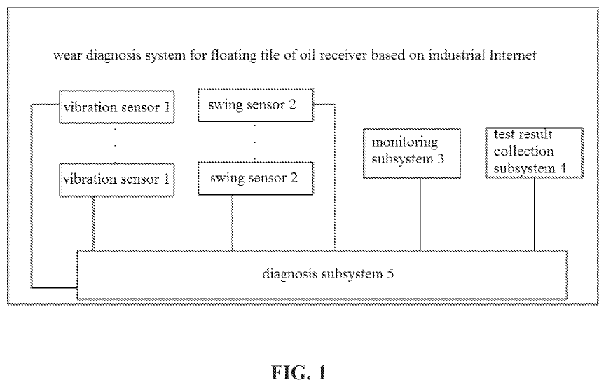

FIG. 1 is a structural diagram of a wear diagnosis system for a floating tile of an oil receiver based on industrial Internet according to an embodiment of the disclosure. As shown in FIG. 1, the system includes multiple vibration sensors 1, multiple swing sensors 2, a monitoring subsystem 3, a test result collection subsystem 4 and a diagnosis subsystem 5;
the plurality of vibration sensors 1 are installed on the oil receiver of a hydroturbine, and the plurality of vibration sensors 1 are configured for collecting vibration data of the oil receiver and sending the vibration data to the diagnosis subsystem 5.

In the embodiment of the disclosure, the plurality of vibration sensors 1 are respectively installed in an X direction and a Y direction of an upstream of the oil receiver of the hydroturbine, and in an X direction and a Y direction of a downstream of the oil receiver.

It should be noted that in order to install the vibration sensor 1, brackets can be welded in X directions and Y directions of the upstream and the downstream of the oil receiver, and the brackets are required to be in line-surface contact with the oil receiver body. The vibration sensor 1 is installed and fixed on the bracket, the sensor cable is connected to the terminal box, and then connected to the diagnosis subsystem 5.

The plurality of vibration sensors 2 are installed on the oil receiver of a hydroturbine, and the plurality of vibration sensors are configured for collecting vibration data of the oil receiver and sending the vibration data to the diagnosis subsystem 5.

In the embodiment of the disclosure, the plurality of swing sensors 2 are respectively installed in an X direction and a Y direction of an end cover on the downstream side of the oil receiver of the hydroturbine.

It should be noted that in order to install the swing sensors 2, brackets can be welded in X direction and Y direction of the end cover on the downstream side of the oil receiver. The gap between the sensor and the rotating shaft of the oil receiver is adjusted, and the gap is required to be 1.5 mm. The swing sensors 2 are installed on the brackets, the sensor cable is connected to the terminal box, and then connected to the diagnosis subsystem 5.

The monitoring subsystem 3 is configured for collecting start-stop information of an oil pump of an oil collecting device of the hydroturbine, an oil level of a hub high-level oil tank and unit load information, and sending the start-stop information of the oil pump of the oil collecting device, the oil level of the hub high-level oil tank and the unit load information to the diagnosis subsystem 5.

The test result collection subsystem 4 is configured for collecting oiling test results of each oil tank of the hydroturbine and sending the oiling test results of each oil tank to the diagnosis subsystem 5.

It should be noted that the oiling test results of each fuel tank include:
an oiling test result of a governor oil-return tank, an oiling test result of the hub high-level oil tank, and an oiling test result of an oil collecting device oil tank;
the oiling test results include granularity and oil color.

The diagnosis subsystem 5 is configured to diagnose whether the floating tile of the oil receiver is worn based on the vibration data and the swing data of the oil receiver, the start-stop information of the oil pump, the oil level of the hub high-level oil tank, the unit load information and the oiling test results of each oil tank.

In the embodiment of the disclosure, the diagnosis subsystem 5 is provided with a vibration data alarm threshold, a swing data alarm threshold, an oil pump start interval threshold, an oil level decline rate threshold, a granularity threshold and a fault oil color.

A calculation formula of the oil pump start interval threshold is as follows:

g=j−j×20%
in the formula, g is the oil pump start interval threshold and j is an oil pump start interval average value.

A calculation formula of the oil level decline rate threshold is as follows:

s=x+x×20%
in the formula, s is the oil level decline rate threshold, and x is an oil level normal decline rate of the hub high-level oil tank.

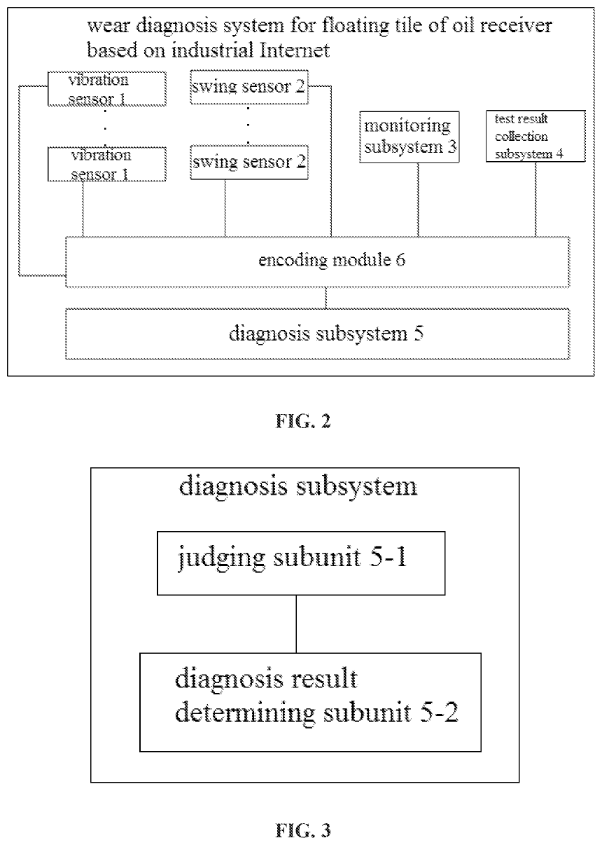

In the embodiment of the disclosure, as shown in FIG. 2, the wear diagnosis system for the floating tile of the oil receiver further includes an encoding module 6.

The encoding module 6 is configured for KKS coding on the vibration data and the swing data of the oil receiver, the start-stop information of the oil pump, the oil level of the hub high-level oil tank, the unit load information and the oiling test results of each fuel tank, before sending the vibration data and the swing data of the oil receiver, the start-stop information of the oil pump, the oil level of the hub high-level oil tank, the unit load information and the oiling test results of each fuel tank to the diagnosis subsystem.

In the embodiment of the disclosure, as shown in FIG. 3, the diagnosis subsystem 5 includes a judging subunit 5-1 and a diagnosis result determining subunit 5-2.

The judging subunit 5-1 is configured to judge whether a first fault occurs based on the unit load information and the vibration data in a preset time period.

In a case of the first fault, the vibration data of the oil receiver continuously increases under a same working condition, and the vibration data is greater than or equal to the vibration data alarm threshold.

The judging subunit 5-1 is further configured to judge whether a second fault occurs based on the unit load information and the swing data in the preset time period.

In a case of the second fault, the swing data of the oil receiver continuously increases under the same working condition under the preset time period, and the swing data is greater than or equal to the swing data alarm threshold.

The judging subunit 5-1 is further configured to judge whether a third fault occurs based on the start-stop information of the oil pump of the oil collecting device in the preset time period.

In a case of the third fault, a start-stop interval time of the oil pump is less than or equal to the oil pump start interval threshold.

The judging subunit 5-1 is further configured to judge whether a fourth fault occurs based on the oil level of the hub high-level oil tank in the preset time period.

In a case of the fourth fault, a drop speed of the oil level of the hub high-level oil tank is greater than or equal to the oil level decline rate threshold.

The judging subunit 5-1 is further configured to judge whether a fifth fault occurs based on the oiling test results, the granularity threshold, and the fault oil color of each oil tank in the preset time period.

In a case of the fifth fault, the oiling test results of each fuel tank are unqualified.

The diagnosis result determining subunit 5-2 is configured for diagnosing a wear of the floating tile of the oil receiver when the first fault, the second fault, the third fault, the fourth fault and the fifth fault occur simultaneously.

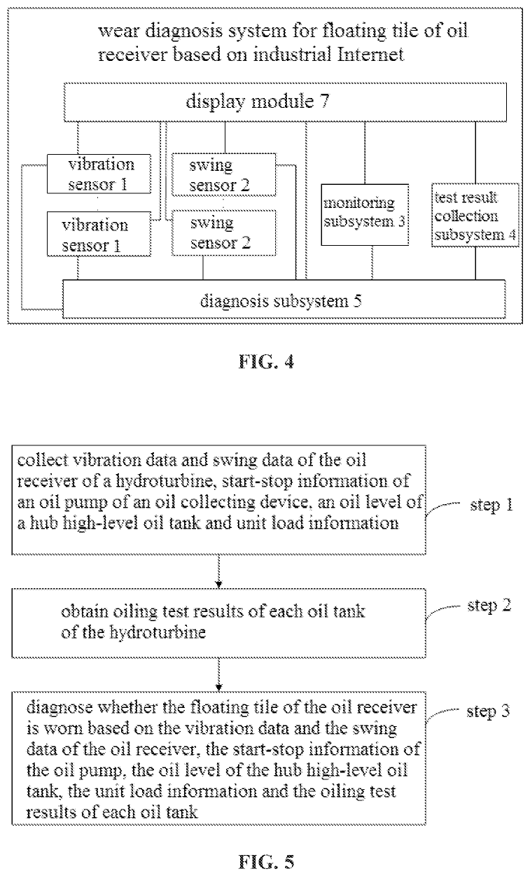

In the embodiment of the disclosure, as shown in FIG. 4, the wear diagnosis system for the floating tile of the oil receiver includes a display module 7.

The display module 7 is respectively connected with the vibration sensors 1, the swing sensors 2, the monitoring subsystem 3, the test result collection subsystem 4 and the diagnosis subsystem 5.
the display module 7 is configured for displaying the vibration data and the swing data of the oil receiver, the start-stop information of the oil pump, the oil level of the hub high-level oil tank, the unit load information, the oiling test results and diagnosis results of each oil tank.

The display module 7 is further configured to display a vibration trend and a swing trend of the oil receiver, a start-stop interval trend of the oil pump of the oil collecting device under a same load and a oil level change trend of the hub high-level oil tank.

It should be noted that the vibration sensors 1, the swing sensors 2, the monitoring subsystem 3, the test result collection subsystem 4 and the diagnosis subsystem 5 communicate with the industrial Internet. Operation and maintenance personnel can monitor the vibration and swing of oil receiver in real time under any load and draw curves, trace the changing trend of vibration and swing of oil receiver and draw curves, monitor the start-stop interval of the oil pump of the oil collecting device under the same load and the oil level change trend of the hub high-level oil tank.

It should be noted that the floating tile in the oil receiver plays a guiding and stabilizing role for the running operating oil pipe. In the operation of the unit, the floating tile can bear the radial load generated by the swing of the rotating shaft and limit the swing of the rotating shaft. Under the same working condition (same load and water head), when the floating tile is seriously worn, the swing of the rotating shaft will increase and the vibration will be greater. In the standard, it is required that the swing degree of the turning wheel of the operating oil pipe of the oil receiver is not greater than 0.1 mm, and the coaxiality of the floating tile seat of the oil receiver and the operating oil pipe is not greater than 0.2 mm. When the floating tile of the oil receiver is worn, the swing of the rotating shaft will increase. Therefore, without disassembly and maintenance, when the swing and vibration of the oil receiver continue to increase under the same working condition, approaching or exceeding the alarm value (the alarm value can be comprehensively analyzed and adjusted according to the actual operation of each unit and the gap between the oil receiver and the rotating shaft designed by the manufacturer), it is determined that the floating tile may be worn.

Because the gravity oil in the hub high-level oil tank is introduced into the rotating operating oil pipe from the fixed oil pipe and transported into the hub body of the wheel, when the floating tile is seriously worn, the gravity oil in the hub high-level oil tank will directly leak to the oil collecting device, and the oil level of the hub high-level oil tank will continue to drop. When drop rate of the oil level of the hub high-level oil tank exceeds 20% or more of the normal average rate (which can be calculated according to the statistical data of each unit, and the drop height of oil level of the hub oil tank every hour), it is determined that the floating tile may be worn.

Because the floating tile isolates and seals the pressure oil in the opening and closing chambers of the blades and the pressure oil in the hub pressure maintaining chamber, the mutual channeling of the pressure oil in each cavity is prevented. Under the same working conditions (same load, generally full load is selected), when the floating tile is seriously worn, the oil leakage amount of the oil receiver will increase, the oil pump of the oil collecting device will be started frequently, and the start interval will be apparently shortened. When the start interval of oil pump of oil collecting device is shortened by 20% or more than the previous average interval, it is judged that the floating tile may be worn.

According to the situation of regular oil sampling and testing, when the floating tile is seriously worn, the turbine oil circulating in the system will be dark in color and the granularity will exceed the standard. This item can be used as an auxiliary judgment condition to determine the problem more clearly.

To sum up, the logical conditions for judging the wear of the floating tile of the oil receiver can be set as follows: under the same working conditions (same load and same water head), when the vibration and swing of the oil receiver continuously increase, approaching or exceeding the alarm value, and the start interval of the oil pump of the oil collecting device is shortened by 20% or more than the previous average interval, and the oil level of the hub high-level oil tank drops by 20% or more than the normal average rate, it can basically be judged that the floating tile is abnormally worn. Combined with the oiling test results of governor oil return tank, hub high oil tank and oil collecting device oil tank, it is confirmed that the floating tile is indeed worn.

In summary, the wear diagnosis system for the floating tile of the oil receiver based on industrial Internet provided in this embodiment can monitor the wear of floating tile of the oil receiver in real time, and improve the accuracy and timeliness of wear discovery of the floating tile of the oil receiver.

### Embodiment 2

FIG. 5 is a flowchart of a wear diagnosis method for the floating tile of the oil receiver based on industrial Internet according to an embodiment of the disclosure, as shown in FIG. 5, the method includes:
step 1: vibration data and swing data of the oil receiver of a hydroturbine, start-stop information of an oil pump of an oil collecting device, an oil level of a hub high-level oil tank and unit load information are collected;
step 2: oiling test results of each oil tank of the hydroturbine are obtained;
step 3: whether the floating tile of the oil receiver is worn is diagnosed based on the vibration data and the swing data of the oil receiver, the start-stop information of the oil pump, the oil level of the hub high-level oil tank, the unit load information and the oiling test results of each oil tank;
where, the vibration data of the oil receiver of the hydroturbine is collected based on multiple vibration sensors respectively installed in an X direction, a Y direction of an upstream of the oil receiver of the hydroturbine, and in an X direction, a Y direction of a downstream of the oil receiver;
the swing data of the oil receiver of the hydroturbine is collected based on multiple swing sensors respectively installed in an X direction and a Y direction of an end cover of the downstream side of the oil receiver of the hydroturbine.

In summary, the wear diagnosis method for the floating tile of the oil receiver based on industrial Internet provided in this embodiment can monitor the wear of floating tile of the oil receiver in real time, and improve the accuracy and timeliness of wear discovery of the floating tile of the oil receiver.

In the description of this specification, descriptions referring to the terms “one embodiment”, “some embodiments”, “examples”, “specific examples” or “some examples” mean that specific features, structures, materials or characteristics described in combination with this embodiment or example are included in at least one embodiment or example of this disclosure. In this specification, the schematic expressions of the above terms are not necessarily aimed at the same embodiment or example. Moreover, the specific features, structures, materials or characteristics described may be combined in any one or more embodiments or examples in a suitable manner. In addition, those skilled in the art can combine and constitute different embodiments or examples and features of different embodiments or examples described in this specification without contradicting each other.

Any process or method description in the flowchart or otherwise described herein can be understood as a module, segment or part representing code including one or more executable instructions for implementing customized logic functions or steps of the process. The scope of the preferred embodiments of the disclosure includes other implementations in which the functions may be performed out of the order shown or discussed, including in a substantially simultaneous manner or in the reverse order according to the functions involved, which should be understood by those skilled in the technical field to which the embodiments of the disclosure belong.

Although the embodiments of the disclosure have been shown and described above, it can be understood that the above embodiments are exemplary and cannot be understood as limitations of the disclosure, and those skilled in the art can make changes, modifications, substitutions and variations to the above embodiments within the scope of the disclosure.

What is claimed is:

1. A wear diagnosis system for a floating tile of an oil receiver based on industrial Internet, comprising a plurality of vibration sensors, a plurality of swing sensors, a monitoring subsystem, a test result collection subsystem and a diagnosis subsystem, wherein:
the plurality of vibration sensors are installed on the oil receiver of a hydroturbine, and the plurality of vibration sensors are configured for collecting vibration data of the oil receiver and sending the vibration data to the diagnosis subsystem;
the plurality of swing sensors are installed on the oil receiver of the hydroturbine, and the plurality of swing sensors are configured for collecting swing data of the oil receiver and sending the swing data to the diagnosis subsystem;
the monitoring subsystem is configured for collecting start-stop information of an oil pump of an oil collecting device of the hydroturbine, an oil level of a hub high-level oil tank and unit load information, and sending the start-stop information of the oil pump of the oil collecting device, the oil level of the hub high-level oil tank and the unit load information to the diagnosis subsystem;
the test result collection subsystem is configured for collecting oiling test results of each oil tank of the hydroturbine and sending the oiling test results of each oil tank to the diagnosis subsystem;
the diagnosis subsystem is configured to diagnose whether the floating tile of the oil receiver is worn based on the vibration data and the swing data of the oil receiver, the start-stop information of the oil pump, the oil level of the hub high-level oil tank, the unit load information and the oiling test results of each oil tank.

2. The wear diagnosis system for a floating tile of an oil receiver based on industrial Internet according to claim 1, wherein the plurality of vibration sensors are respectively installed in an X direction and a Y direction of an upstream of the oil receiver of the hydroturbine, and in an X direction and a Y direction of a downstream of the oil receiver;
the plurality of swing sensors are respectively installed in an X direction and a Y direction of an end cover on the downstream of the oil receiver of the hydroturbine.

3. The wear diagnosis system for a floating tile of an oil receiver based on industrial Internet according to claim 2, wherein the wear diagnosis system for the floating tile of the oil receiver further comprises an encoding module;
the encoding module is configured for KKS coding on the vibration data and the swing data of the oil receiver, the start-stop information of the oil pump, the oil level of the hub high-level oil tank, the unit load information and the oiling test results of each fuel tank, before sending the vibration data and the swing data of the oil receiver, the start-stop information of the oil pump, the oil level of the hub high-level oil tank, the unit load information and the oiling test results of each fuel tank to the diagnosis subsystem.

4. The wear diagnosis system for a floating tile of an oil receiver based on industrial Internet according to claim 3, wherein the oiling test results of each fuel tank comprise:
an oiling test result of a governor oil-return tank, an oiling test result of the hub high-level oil tank, and an oiling test result of an oil collecting device oil tank;
wherein the oiling test results comprise granularity and oil color.

5. The wear diagnosis system for a floating tile of an oil receiver based on industrial Internet according to claim 4, wherein the diagnosis subsystem is provided with a vibration data alarm threshold, a swing data alarm threshold, an oil pump start interval threshold, an oil level decline rate threshold, a granularity threshold and a fault oil color.

6. The wear diagnosis system for a floating tile of an oil receiver based on industrial Internet according to claim 5, wherein a calculation formula of the oil pump start interval threshold is as follows:
g=j−j×20%
wherein g is the oil pump start interval threshold and j is an oil pump start interval average value;
a calculation formula of the oil level decline rate threshold is as follows:
s=x+x×20%
wherein s is the oil level decline rate threshold, and x is an oil level normal decline rate of the hub high-level oil tank.

7. The wear diagnosis system for a floating tile of an oil receiver based on industrial Internet according to claim 5, wherein the diagnosis subsystem comprises a judging subunit and a diagnosis result determining subunit;
the judging subunit is configured to judge whether a first fault occurs based on the unit load information and the vibration data in a preset time period;
the judging subunit is further configured to judge whether a second fault occurs based on the unit load information and the swing data in the preset time period;
the judging subunit is further configured to judge whether a third fault occurs based on the start-stop information of the oil pump of the oil collecting device in the preset time period;
the judging subunit is further configured to judge whether a fourth fault occurs based on the oil level of the hub high-level oil tank in the preset time period;
the judging subunit is further configured to judge whether a fifth fault occurs based on the oiling test results, the granularity threshold, and the fault oil color of each oil tank in the preset time period;
the diagnosis result determining subunit is configured for diagnosing a wear of the floating tile of the oil receiver when the first fault, the second fault, the third fault, the fourth fault and the fifth fault occur simultaneously.

8. The wear diagnosis system for a floating tile of an oil receiver based on industrial Internet according to claim 6, wherein in a case of the first fault, the vibration data of the oil receiver continuously increases under a same working condition, and the vibration data is greater than or equal to the vibration data alarm threshold;
in a case of the second fault, the swing data of the oil receiver continuously increases under the same working condition under the preset time period, and the swing data is greater than or equal to the swing data alarm threshold;
in a case of the third fault, a start-stop interval time of the oil pump is less than or equal to the oil pump start interval threshold;
in a case of the fourth fault, a drop speed of the oil level of the hub high-level oil tank is greater than or equal to the oil level decline rate threshold;
in a case of the fifth fault, the oiling test results of each fuel tank are unqualified.

9. The wear diagnosis system for a floating tile of an oil receiver based on industrial Internet according to claim 1, wherein the wear diagnosis system for the floating tile of the oil receiver comprises a display module:
the display module is respectively connected with the vibration sensors, the swing sensors, the monitoring subsystem, the test result collection subsystem and the diagnosis subsystem;
the display module is configured for displaying the vibration data and the swing data of the oil receiver, the start-stop information of the oil pump, the oil level of the hub high-level oil tank, the unit load information, the oiling test results and diagnosis results of each oil tank;
the display module is further configured to display a vibration trend and a swing trend of the oil receiver, a start-stop interval trend of the oil pump of the oil collecting device under a same load and a oil level change trend of the hub high-level oil tank.

10. A wear diagnosis method for a floating tile of an oil receiver based on industrial Internet using the wear diagnosis system for a floating tile of an oil receiver based on industrial Internet according to claim 1, wherein the wear diagnosis method comprises:
collecting vibration data and swing data of the oil receiver of a hydroturbine, start-stop information of an oil pump of an oil collecting device, an oil level of a hub high-level oil tank and unit load information;
obtaining oiling test results of each oil tank of the hydroturbine;
diagnosing whether the floating tile of the oil receiver is worn based on the vibration data and the swing data of the oil receiver, the start-stop information of the oil pump, the oil level of the hub high-level oil tank, the unit load information and the oiling test results of each oil tank;
wherein, the vibration data of the oil receiver of the hydroturbine is collected based on a plurality of vibration sensors respectively installed in an X direction, a Y direction of an upstream of the oil receiver of the hydroturbine, and in an X direction, a Y direction of a downstream of the oil receiver;
the swing data of the oil receiver of the hydroturbine is collected based on a plurality of swing sensors respectively installed in an X direction and a Y direction of an end cover of the downstream of the oil receiver of the hydroturbine.
